(19) United States
(12) Patent Application Publication
(10) Pub. No.: US 2018/0083451 A1
(43) Pub. Date: Mar. 22, 2018

(54) METHOD AND SYSTEM FOR OPERATING A PLURALITY OF PHOTOVOLTAIC (PV) GENERATING FACILITIES CONNECTED TO AN ELECTRICAL POWER GRID NETWORK

(71) Applicant: Sun Electric Pte Ltd., Singapore (SG)

(72) Inventor: Matthew Peloso, Singapore (SG)

(21) Appl. No.: 15/566,514

(22) PCT Filed: Jun. 19, 2015
(86) PCT No.: PCT/SG2015/050172

§ 371 Date: Oct. 13, 2017

(30) Foreign Application Priority Data
Apr. 15, 2015 (SG) 10201502972V

(51) Int. Cl. H02J 3/38; H02J 13/00; H02S 50/00; G05B 19/042

(52) U.S. Cl. CPC H02J 3/383; H02J 13/0079; G05B 2219/2639; G05B 19/042; H02S 50/00

(57) ABSTRACT

A method and system for operating a plurality of photovoltaic (PV) generating facilities connected to an electrical power grid network. The method comprises the steps of obtaining data about each of the plurality of PV generating facilities; filtering the obtained data to establish one or more selected PV generating facilities out of the plurality of PV generating facilities; and executing an operation routine for said one or more selected PV generating facilities for execution.

### FIELD OF INVENTION

The present invention relates broadly to method and system for operating a plurality of photovoltaic (PV) generating facilities connected to an electrical power grid network.

### BACKGROUND

Photovoltaic (PV) generators are becoming more prevalent for generation of energy. PV generators are DC energy systems, where the incidence of sunlight on a semiconductor material leads to a flow of charge through a closed circuit. This flowing charge may provide electrical power for a building or can be injected into a power transmission network. A PV generator system is typically comprised of an array of individual PV modules which are constructed to cover a specific area providing a power capacity. The incident sunlight on the area of coverage of the solar module is converted into electrical power. The solar PV module holds a plurality of individual solar cells, and these cells are wired together so as to establish a particular power output with characteristic voltage and current from the individual electrical component. Such PV modules are use to cover a particular area so as to increase a power systems output. Stringing of these modules together is performed to connect the whole system for electricity generation.

One growing type of installation is a rooftop based system. In this case, a solar power system is installed on a framing support system on top of a building and connected as possible to either the buildings service cable, distribution board, or directly to the power grid (reference the interconnection patent). The stringing of the solar PV modules uses both series and parallel connections. Thus, an array of solar panels typically will include a number of strings in series, and a number of parallel strings. These stringing arrangements determine the voltage and current of the entire PV array. The Handbook of Photovoltaic Science and Engineering by A. Luque and S. Hegedus [Handbook of Photovoltaic Science and Engineering, 2nd Edition, Antonio Luque (Editor), Steven Hegedus (Co-Editor); ISBN: 978-0-470-72169-8] is referenced here for a description of details of solar PV systems stringing procedures and on the electrical characteristics of the PV module components. We refer herein to a generating facility as single array of generators of a specific power capacity as dependent on the number of photovoltaic modules installed, an as strung to include a number of inverters that will convert the DC electrical current to an AC electrical current.

One paradigm for solar has been the utility model, wherein a large area is used for support of solar panels. A new trend refers to a fragmented approach, where smaller generating facilities are disposed at many locations of an urban city power grid network. Due to the increasing prevalence of such installations, the density of new generators that either interconnect to the power grid network, or connect to the distribution board or service cable of a building, is increasing. In turn, the introduction of these resources onto the grid affects a variety of factors and modifies the manner in which resources should be controlled. A power systems operator (PSO) may face new opportunities in the manner they dispatch other generators connected to their network due to the new facilities installed, and may face modified requirements to meet the load demand and supply of energy on the power grid. This density of new interconnected generating facilities to a particular urban energy network is expected to increase over the coming decade. As such, a PSO will be faced with managing not only the conventional energy generators that combust fuels to meet the balance of demand and supply of loads and generators of an urban energy network, but also to account for new generation technologies that will have generation profiles dependent on an external resource, while a AC electrical power grid network administrator will face new challenges in terms of administering safe control, isolation, and procedures of the power grid due to the new density of generating facilities which interface the AC power grid network.

Embodiments of the present invention provide a method and system for operating a plurality of photovoltaic (PV) generating facilities connected to an electrical power grid network that seek to address at least one of the above problems.

### SUMMARY

In accordance with a first aspect of the present invention, there is provided a method for operating a plurality of photovoltaic (PV) generating facilities connected to an electrical power grid network, the method comprising the steps of obtaining data about each of the plurality of PV generating facilities; filtering the obtained data to establish one or more selected PV generating facilities out of the plurality of PV generating facilities; and executing an operation routine for said one or more selected PV generating facilities for execution.

In accordance with a second aspect of the present invention, there is provided a system for operating a plurality of photovoltaic (PV) generating facilities connected to an electrical power grid network, comprising means for obtaining data about each of the plurality of PV generating facilities; means for filtering the obtained data to establish one or more selected PV generating facilities out of the plurality of PV generating facilities; and means for executing an operation routine for said one or more selected PV generating facilities for execution.

In accordance with a third aspect of the present invention, there is provided an aggregate generating facility comprising a plurality of PV generating facilities, each PV generating facility being configured to establish two way communication to an operation centre and comprising a functional control apparatus, for establishing an operating platform of the aggregate generating facility.

In accordance with a fourth aspect of the present invention, there is provided an operation centre for a plurality of PV generating facilities, the operation centre being configured to establish two way communication to each of the generating facilities, wherein the operation centre is further configured to identify a set of the PV generating facilities and to execute commands to respective functional control apparatus of the set of PV generating facilities.

In accordance with a fifth aspect of the present invention, there is provided an operation method for a plurality of PV generating facilities comprising performing an operation routine one or more PV generators at each of one or more of the PV generating facilities using a central operation platform.

Example embodiments of the present invention advantageously provide an integration of new elements within a hardware module. This hardware module is interfaced to the inverters of the generating facility. It is enabled so as to obtain data from a variety of sources locally to the generating facility, for example but not limited to, irradiance data, wind speeds, thermal information from a thermistor, inverter voltages, waveforms, performance ratios of the PV system, information reflecting the AC power grid network, additional signal lines connected to features of the building, and other information. Information may also be stored remotely at the operation centre, for example, the location or address of the PV system, specifications of the system, or other information associated with a particular installation. The hardware module is also advantageously enabled so that a control system may be implemented to affect elements incorporated within the AC electrical inverters. The elements may be affected by a local control command that is placed onto an operating memory and processor at the local hardware module, or from a remote operation centre. Notably, the operation centre is advantageously equipped so as to be able to send new software procedures to be embedded locally to information storage of the hardware module for implementation via the memory and a programmable logic controller (PLC) in the hardware module. The control system(s) can preferably be implemented in a manner that switching operations may be triggered either remotely or from the hardware module which may receive an event or signal. The control system(s) can preferably be implemented in a manner that synchronization of the AC waveforms may be controlled either remotely or from the hardware module which may receive an event or signal. The control system(s) can preferably be implemented in a manner that reactive power control may be performed either remotely or from the hardware module which may receive an event. Various isolation procedures can preferably be enabled remotely or at the hardware module. The operation centre can preferable be equipped to host information received from the generating facilities connected, or received from a third party. A third party may be the AC power grid network administrator or the power system operator. Third party information may be hosted on an encrypted platform so that the solar PSO (used herein to describe the operator for the photovoltaic generating facilities) is unable to reproduce the precise data obtained from the third party. The operation centre can preferably be equipped to filter information such that a generating facility or pluralities of generating facilities which match specific criteria are identified. This advantageously allows for an upload routine to be performed by the hardware module, or a direct procedure to be performed by the operation centre so as to control the generating facility or facilities through the hardware module.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a plurality of generating facilities disposed at locations of an urban power grid network according to an example embodiment.

FIG. 2 shows a schematic drawing illustrating an operation system according to an example embodiment.

FIG. 3 shows a schematic drawing illustrating a power system operator facilitating control procedures and data exchange with a solar power system operator according to an example embodiment.

FIG. 4 shows a schematic diagram illustrating a PV generating facility for an operation system including a hardware module according to an example embodiment.

FIG. 5 shows a schematic drawing illustrating one potential AC electrical interconnection system illustrating AC disconnect and breakers for isolation where a connection point is a building service cable, according to an example embodiment.

FIG. 6 shows a schematic drawing illustrating another potential AC electrical interconnection system illustrating AC disconnect and breakers for isolation where a connection point is a power grid substation, according to an example embodiment.

FIG. 7 shows a flow-chart illustrating a method for operating a plurality of photovoltaic (PV) generating facilities connected to an electrical power grid network, according to an example embodiment.

FIG. 8 shows a schematic drawing illustrating a system for operating a plurality of photovoltaic (PV) generating facilities connected to an electrical power grid network, according to an example embodiment.

### DETAILED DESCRIPTION

Embodiments of the present invention relate to Photovoltaic (PV) generators installed in proximity of an urban AC electrical power grid network connected and upgraded with an advanced hardware module so as to allow an interface to an operation centre for receiving of communications, sending of communications, and executing of command signals through a programmable logic controller incorporated at the hardware module. A local routine may also be performed from the hardware module equipped with its own storage space, memory card, and processor; and/or written by the operation centre for execution of commands by the hardware module. Thus, the hardware module preferably incorporates a processor and information storage capacity to allow operation of the PV generators, including control, processing, and storage of local routines which can be updated by the operation centre via communication links connecting the hardware module to the operation centre.

Control signals to any generating facility may influence reactive control, isolation and breakers, synchronisation events, islanding procedures, and other functionalities and/or elements of the electrical systems which interface the DC PV generator(s) to the AC electrical power grid network through the inverters and hardware module. This operation centre is advantageously equipped to issue commands to the generating facilities and also receive information from the generating facilities from their data logger and information storage capacity. Each installation preferably includes a Programmable Logic Controller (PLC) unit within the hardware module for issuing control commands e.g. to the inverter or to associated electrical equipment facilitating a connection point of the generating facility, or the string of inverters at a particular generating facility; a data acquisition module for gathering local data at the generating facility such as temperature using a thermistor or PT100 sensor, irradiance sensors, and other kinds of sensors, and a networking module that can communicate to a telecommunications network both wirelessly and/or through a local Ethernet port. Where possible, both Ethernet and wireless networking links may be used for redundancy. In addition, this networking unit preferably includes an amount of information storage space, and an amount of processing allowance. This advantageously allows the units to be connected to the remote operation centre which in turn allows the remote operation centre to hand over a function of routines to the PSO to issue certain commands to any set of the installations, to all installations, or to individual generating facilities both remotely, and with an adaptable local procedure that can be updated at the operation centre and then loaded into a set of generating facilities for execution from the hardware module.

The operation centre is comprised of a server connected to the internet in one embodiment. This server is able to communicate to and receive from all hardware modules, and may identify each hardware module using a unique identification number. The server can obtain information from each hardware module in real time and store such data in an information storage space. In addition, the operation centre server can obtain information that has been stored in the data logger of a generating facilities hardware module. The information obtained from the hardware modules comprises characteristic information of the generating facility. For example, thermal information, local irradiance information, or voltages of the inverters can be recorded at the operation centre. The server is preferably equipped with a certificate for encryption and secure communication so that information sent and received by the server can be securely sent and received. The operation centre server can also obtain information from the local PSO, as well as the local AC power grid network administrator. Such information can be associated with various information of the generating facilities. For example, the AC power grid network administrator may identify a generating facility to its connection point on the grid, and to the nearest local electrical apparatus of the AC electrical power grid network such as a transformer, substation, or other equipment. The information can also be associated using a multiplier, for example, the proximity of the generating facility to a particular electrical component installed within the AC electrical power grid network.

### Operation of an Aggregate Generating Facility

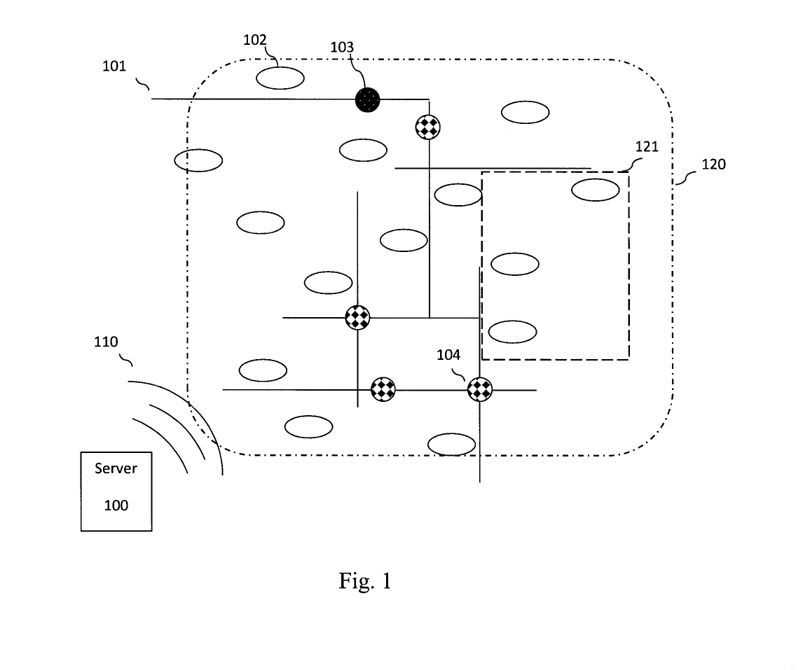

FIG. 1 shows a schematic diagram illustrating a plurality of generating facilities disposed at locations of an urban power grid network according to an example embodiment. Numeral 100 indicates an operation centre server of the solar PSO. Indicated with numeral 101 is an AC electrical power grid network, while numeral 102 indicates a respective generating facility in proximity to an AC electrical power grid network, numeral 103 represents equipment of the AC power grid network 101, and numeral 104 represents substations at a particular point of the AC electrical power grid network 101. Numeral 110 represents a communication link from the operation centre server 100 to the plurality of generating facilities 102. Indicated at numeral 120 is an aggregate of a plurality of generating facilities 102 equipped with hardware modules (not shown) incorporated thereat with which the operation centre server 100 is in communication to the aggregate generating facility 120, and numeral 121 indicates a set of the aggregate of generating facilities 120, for which a particular command routine has been selected for execution on each of the generating facilities of the set 121.

The operation centre server 100 comprises a computer module, input modules such as a touchscreen, keyboard and mouse and a plurality of input and/or output devices such as a display, printer, etc.

The computer module is connected to a computer network via a suitable transceiver device to enable access to the Internet and or other network systems such as a Local Area Network (LAN) or a Wide Area Network (WAN). The computer module in the example includes a processor, a Random Access Memory (RAM) and a Read Only Memory (ROM). The computer module also includes a number of Input/Output (I/O) interfaces, for example an I/O interface to the display and an I/O interface to the keyboard.

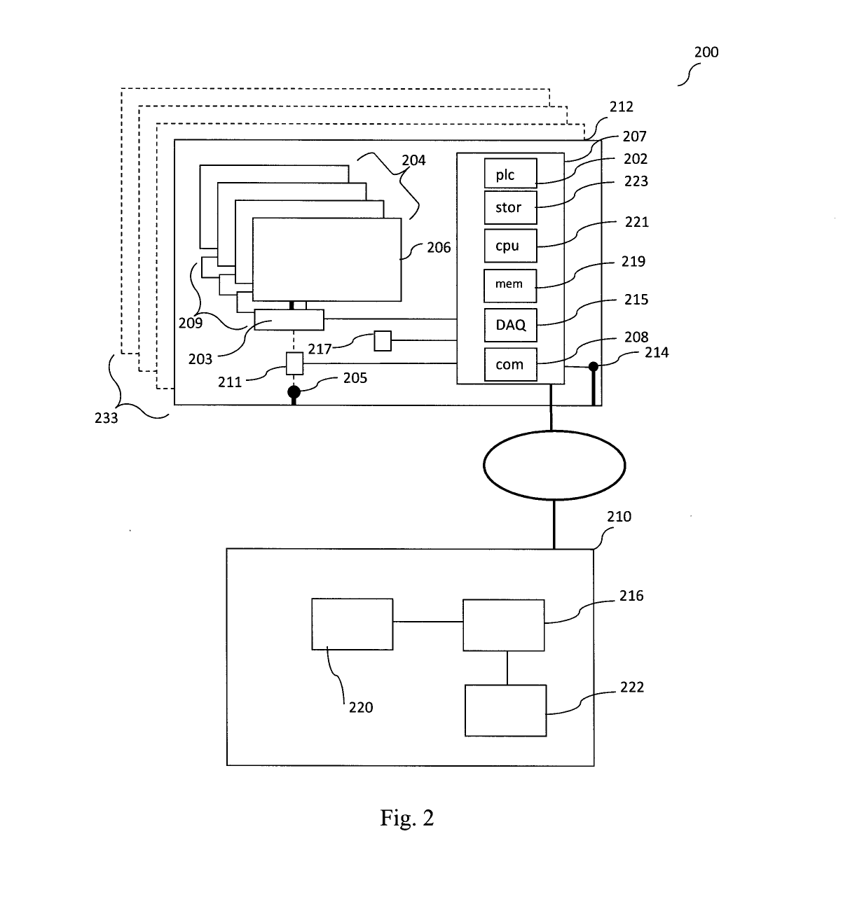

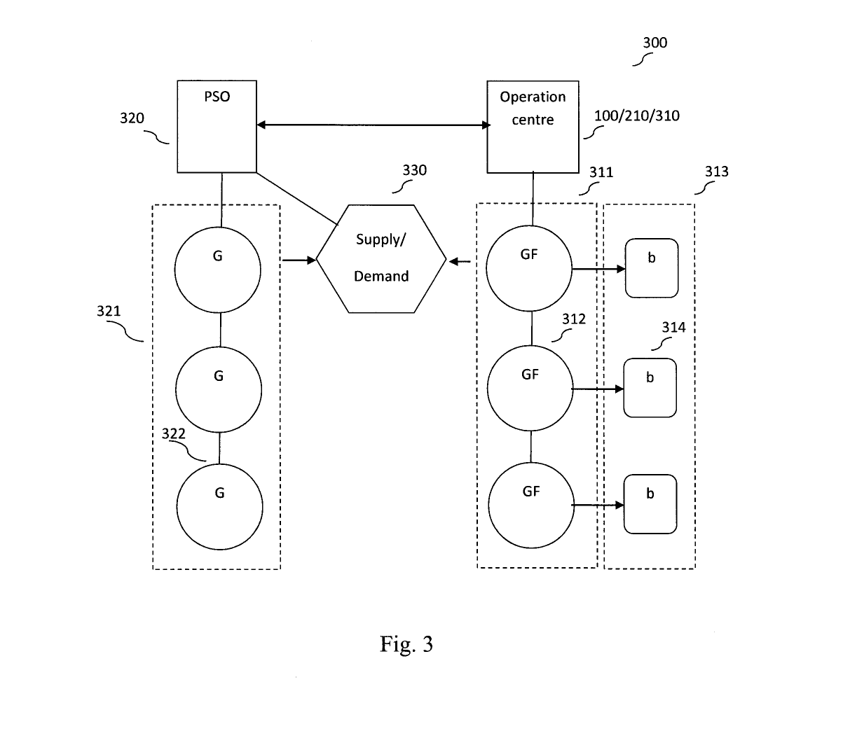

The components of the computer module typically communicate via an interconnected bus and in a manner known to the person skilled in the relevant art. Application program(s) for instructing the computer module to implement the operation centre server 100 in FIG. 1 (or the operation centre 210 in FIG. 2 or the operation centre 310 in FIG. 3) is typically supplied to the user of the computer system encoded on a data storage medium such as a CD-ROM or flash memory carrier and read utilizing a corresponding data storage medium drive of a data storage device. The application program is read and controlled in its execution by the processor of the computer module. Intermediate storage of program data may be accomplished using the RAM of the computer module. The present specification discloses methods and apparatus for implementing or performing the operations of the methods. Such apparatus may be specially constructed for the required purposes, or may comprise a device selectively activated or reconfigured by a computer program stored in the device. Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a device. The computer readable medium may also include a hard-wired medium such as exemplified in the Internet system, or wireless medium such as exemplified in the GSM mobile telephone system. The computer program when loaded and executed on the device effectively results in an apparatus that implements the steps of the method.

The invention may also be implemented as hardware. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

### Infrastructure Comprising an Aggregate PV Generating Facility

FIG. 2 shows a schematic drawing illustrating an infrastructure comprising an aggregate PV generating facility 233 according to an example embodiment. A single generating facility 212 includes a PV array 204 which incorporates a plurality of individual strings of PV modules 206, and a hardware module 207 coupled to the PV generators 206 through the AC inverter elements 209 (for example AC string inverter elements) wherein numeral 203 indicates an individual AC inverter. The hardware module 207 can include a networking module 208 which can incorporate both “4G” and a physical Ethernet link connection with the building itself for redundancy; a PLC controller 202 coupled through to issue commands or automation routines to various elements incorporated within the generating facility 212, including in this embodiment to AC inverters 209 coupled to the PV generators 206, and one or more breakers 211 disposed between the AC output from the AC inverters 209 and the grid connection 205 to the AC electrical power grid network. The AC inverters 209 can be provided with, or coupled to, various elements for synchronization, AC disconnection, reactive power control, and islanding, which can advantageously be issued commands from the PCL controller 202 which is a component of the hardware module 207, as will be described below in more detail. Various forms of interconnection, generally illustrated as a grid connection apparatus at numeral 205, to the power grid may be installed. Moreover, the generating facility 212 may be interconnected directly to the AC electrical power grid network, or it may be installed indirectly through a buildings distribution board. Two examples of AC interconnections will be described below. Numeral 233 is an aggregate of generating facilities 212 each advantageously coupled to the operation centre 210.

The hardware module 207 further comprises a data acquisition unit 215 for gathering local data at the generating facility 212 from associated elements such as the PV array 204, the AC inverters 209, and the grid connection apparatus 205, including feedback information via synchronizer unit(s) of the AC inverters 209, or via one or more sensors 217, such as temperature data using a thermistor or PT100 sensor, irradiance data from irradiance sensors, and data from other kinds of sensors, including data obtained via the AC inverter/s 203/209 as “sensors”, such as waveform measurement data and feedback data. The hardware module 207 in the example embodiment is moreover equipped with a local memory 219, processor 221, and an amount of storage space 223. As such, commands may not only be performed from a remote operation centre 210 via the networking module 208, but may be loaded to the hardware module 207 for performance on a local event, for example, in the event that the telecommunications network is not working protocols may be performed via the hardware module 207 itself.

The hardware module 207 can be used to, for example, control reactive power, to modify synchronisation, and to control the AC electronics of the PV generator facility 212 including the PV array 204 and AC inverters 209. Advantageously, the hardware module 207 as incorporated at any of the generating facilities 212 may remotely obtain a signal and command that can be implemented at one or more of the individual generating facilities 212, or at a set of a total number of generating facilities 212 of the aggregate generator 233. Identification of the individual or set of generating facilities from the aggregate generating facility 233 may be performed by filtering of the various data that is measured through the incorporated sensors, that is recorded (for example as a specification) in reference to a particular generating facility 212, or that may be obtained externally and associated with any of a generating facility 212 and stored in the remote operation centre 210.

The operation centre 210 may be a cloud computing platform, or a server operated by the solar power system operator (Solar PSO). The operation centre 210 may advantageously provide for obtaining of information from the AC electrical power grid network or the AC power grid network administrator, for the network operators administration procedures to be implemented, and may advantageously provide for obtaining of information from the PSO in regard to their dispatch strategy. In addition, the operation centre 210 may send information to the PSO so that the PSO may modify their own control procedures for dispatch strategies implemented.

### Third Party Introduction of Information

Layers of the data that are obtained for the operation centre 210 may be encrypted, so that, advantageously, for example, the AC electrical power grid network administrator can incorporate their own technical data into the system for use in the filtering procedures that will select the set of generating facilities 212 which will receive a command. As an example, the AC electrical power grid network administrator may incorporate the information representing the locations of their own substations, the network voltages, capacity factors or transmission characteristics of infrastructure, and the like. This information can then be used by that AC electrical power grid network administrator to confidentially allow a routine to be performed. For example, all generating facilities 212 within the proximity of a particular substation may be issued an isolation command whereby the AC disconnect switch is set to off position remotely. A local sensor of the hardware module 207 can then obtain the reading for testing that the command had safely implemented the disconnection routine. As of obtaining the verification information, the AC electrical power grid network administrator can infer that the isolation routine had been safely performed.

The remote operation centre 210 works in parallel to management routines that are physically implemented on or at the generating facility 212. For example, the generating facility 212 may have a direct signal line 214 at the building that is linked to the fire command (not shown). In the event the fire alarm goes off, the signal line 214 can trigger directly a cut off event at the generating facility 212 of the individual building that has the fire alarm going. This information can be sent through the networking module 208 to the operation centre 210. In different embodiments, other intertrip and interlock signals can be additionally or alternatively incorporated physically at the generating facility 212 for performance on an individual basis. An anti-islanding system can also be used either incorporated physically at the generating facility 212 and/or in the operation centre 210.

Moreover, an adaptive scenario can be implemented by the operation centre 210 by allowing new protocols to be uploaded to a set of generating facilities of the aggregate generating facility 233 for implementation. For example, the operation centre 210 can set the status of a generating facility 212 and then incorporate a signal into execution of the protocol. Thus, new protocols can be written from the operation centre 210 into a set of generating facilities enabled to then adopt a new command procedure.

### Isolation and Reactive Power Control

Islanding refers to the state where a generator continues to create power even when a power distribution network is not powered from an independent electric utility. For example, a power blackout may occur, while a solar energy generator continues to perform and generate power and a voltage at the connection. In this instance, the generator is said to create an island. This situation can be dangerous for utility workers or others, and can also damage hardware at the network. For example, a utility network may assume that a power blackout has occurred when no voltage is present on the supply grid input connection of a distribution board to be worked on. This worker may then receive an electrical shock since the islanding of a generator upstream from the distribution board leads to an additional power source or voltage at the distribution board, even though a supply grid blackout has occurred.

With intentional islanding, the generator will continue to generate power even during a blackout or shut down servicing event. If the generator is a solar energy system, there will be power so long as sunlight is incident on the photovoltaic or thermal converters. In this case, the supply line from the generator becomes an island surrounded by a “sea” of unpowered conductors. This could be utilized for power backup for example. If the intentional islanding is wanted, the generator may disconnect from the grid and is forced to power a local electric load for example.

When islanding is determined to be unsafe, an automatic anti-islanding shut down mechanism can be used. This can be done by using a de-synchronization method from the grid. Synchronizers are electrical components which will detect the waveform of a power distribution network, and will then provide an output signal which conforms to the AC power grid. The PV generators 206 are typically equipped with an AC inverter 209 which will take a DC power input and release an AC power output. These AC inverters 209 may also be implemented with an internal synchronizer such that an output at the AC inverter which is synchronized. Thus, the AC inverter/synchronizer will then be able to perform an anti-islanding operation for a safe shut down procedure. This can effectively isolate the generator from the power grid. The de-synchronization can be set to occur when the supply is disrupted, or when the grid goes outside of pre-set voltage parameters, to prevent islanding.

Additionally or alternatively to an AC isolation trip as described above, the synchronisation of the generating facility 212 can be performed, or reactive power control of the generating facility 212 can be performed, using the central operation platform implemented in example embodiments and optionally a stabilized reference clock of the one or more selected generating facilities. For example, a reference waveform can be set and the AC inverter/synchronizer of the PV generators 206 can be controlled to establish higher power quality. All AC inverters 203 of one or more of the generating facilities 212 (including all generating facilities 112) on the power network, or of a set of the AC inverters 203 at any one or more of the generating facilities 212 (including all generating facilities 112) on the power network, could lock to one harmonic. This may allow for example, an island to form on a particular region of the AC electrical power grid network by selecting the generating facilities that are all interconnected through to a specific node of the network, and locking their frequency to that waveform. It may also allow reactive power control to be implemented based on characteristic features of the AC electrical power grid network through association to the filtered generating units or AC electrical inverters in the generating units.

As an example embodiment of reactive power control, leading and lagging limits of the generating facilities power factor may be implemented to control the generating facility 212 transmission connection rated power through the PLC interface to the inverter synchronizer units. Identifying a set of the aggregated generating facility 233 through filtering, e.g. the generating facilities 212 of proximity to a particular AC electrical power grid network component or location, the balanced statistical power factor can be computed based on which reactive control events are completed accounting for control of two or more generating facilities 212. For example, the statistics of more than one power generating facilities 212 would modify the required reactive power control needed when there is a density of generating facilities 212 incorporated with proximity to particular component(s) of the AC electrical power grid network. In the individual case, a remote reactive power control can be implemented by facilitating two-way communication so that the operation centre 210 can detect information at the generating facility 212 through the hardware module 207 and issue back command(s) for either direct implementation, or for implementation from the storage space 223 of the local hardware module 207.

### Methods of Selection of a Set of Generating Facilities 212 of the Aggregate Generating Facility 233

The operation centre 210 can advantageously be used to perform a number of functions towards a set of generating facilities 212, or as sent globally to all the generating facilities 212 of the aggregate generating facility 233, or individually to each generating facility 212. For example, the operation centre 210 can apply a filtering unit 216 to filter through the data obtained from the generating facilities 212 and/or other data sources and aggregated in a data storage unit 220, to identify, for example, a set of the generating facilities 212 to which a particular command from a command data base 222 can be sent.

### Encryption of Third Party Information

The data stored in the data storage unit 220 can include data from a layer of encrypted data provided under the jurisdiction of the PSO, or a Network Provider, and the PSO or Network Provider can add their own commands in the command data base 222 (or a separate command data base, not shown) and/or data in the data storage unit 220 (or a separate data base, not shown) to apply the filtering unit 216 (or a separate filtering unit, not shown) to identify, for example, a set of the generating facilities 212 to which a particular command from the command data base 222 can be sent.

### Operation Procedure Examples of the Aggregate Generating Facility

The filtering unit 216 can also be configured for maintenance operations, for example to filter out all of the generating facilities 212 where the irradiance reading at the generating facility 212 is higher than the voltage reading at the generating facility 212, which can detect if the panels at the generating facility 212 are not clean. Another example is to obtain a measurement from a thermistor at the generating facility 212, to see if the panel warranty needs to be claimed on. Operation and maintenance procedures may for example apply the filtering methods to identify the set to which an instruction sequence can be sent. This can involve maintenance routines which will be performed from time to time, such as for instructing of which PV module string 206 of the PV array 204 shall be cleaned, or may be done to identify defective parts that may need to be called on a warranty. The technical implementation of such operations and maintenance procedures in example embodiments can advantageously lower the cost of insuring infrastructure due to the lower risk of breakage, financial loss, etc. In addition, the performance output of the PV array 204 can be increased on average due to the ability to identify which PV generators are to be improved. This information can be obtained in real time, and so events can also lead to maintenance procedures that are executed by the Solar PSO.

The PSO could also for example send a signal through to instruct a generating facility 212 to provide its power to a secondary storage medium (not shown) to be saved for use at a later time. This would effectively enable the PSO to limit supply to balance the demand and supply of energy on the AC electrical power grid network while minimising the waste of resources. Alternatively, the generating facility 212 may be isolated or its power output reduced so as to balance the supply. As an alternative to utilisation of a storage medium, the PSO could implement a routine that would limit solar power output to the AC electrical power grid network by implementing turn on of a standby load (not shown) connected near to the generating facility 212.

In addition, the PSO could use the solar PSO to collect information in regard to the total aggregate output, or the total aggregate output of a subset of the aggregate solar power system. For example, the PSO may wish to limit demand on a specific node of the power grid network. Using the operation centre 210, the PSO could implement a filter to obtain the set of generating facilities 212 within proximity to a particular substation of the power grid network. They could then use the solar PSO to measure the immediate supply at that particular node of the network from those generating facilities 212 obtained through the characteristics of the filter employed. This information may then allow the PSO to complete a new dispatch routine to other generators on the power grid network.

FIG. 3 shows a schematic drawing illustrating the information flow between the operation centre 100/210/310 and the PSO 320, including the data exchange and allowance for control over flows of energy in a pool 330 featuring a particular supply and demand characteristic that is detected by the PSO 320. The operation centre 100/210/310 facilitates information flow from the PSO 330 towards a set of generating facilities 311. Numeral 312 is a generating facility for which numeral 314 is an auxiliary electrical reserve. An auxiliary electrical reserve could, for example, be a power storage system, a specific load attached at the generating facility 312, or a reserve. It may also provide for a dump so that energy may be diverted but unused. Numeral 313 is a group of auxiliary electrical reserve devices, the total capacity of which is provided as a resource for backup in the events the PSO 320 requires. The set of generating facilities 311 comprise photovoltaic generators and as such their output is intermittent and relies on irradiance of sunlight for output at any particular time. Numeral 321 is a set of dispatchable generators which combust fuels, while numeral 322 is an individual dispatchable generator. The PSO 320 may send dispatch signals through to both photovoltaic generating facilities e.g. 312 via the operation centre 310 and to generators e.g. 322.

### Description of Physical Embodiments of a Generating Facility

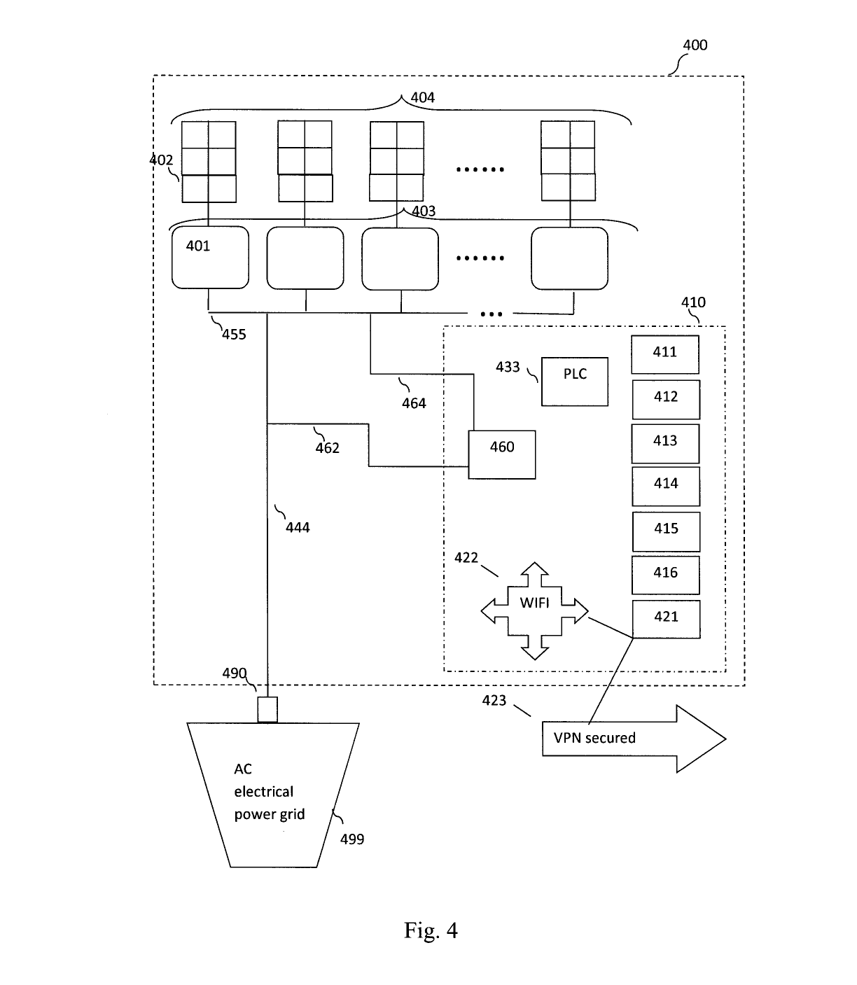

FIG. 4 shows a schematic diagram illustrating a PV generating facility 400 for an operation system according to an example embodiment. 401 is an individual inverter accepting input from a DC photovoltaic array string 402. A PV generator 404 comprises an array/group of PV generators 402 strung through a string of output AC inverters 403. The output of the generating facility 400 is composed such that it is integrated into a suitable interconnection point 490 of an AC electrical power grid network 499. Numeral 410 is a hardware module comprised of communication facilities including an Ethernet port 421, and/or a wireless and/or 3G/4G router and or SIM card chip 422, possibly with redundancy, which interface to a VPN secured network 423; a PLC 433; a digital input 413 and digital output 414; a processor and CPU along with information storage 411; and a suitable RS communication link 412 for connection to the inverters 403, to additional monitoring units (not shown) which incorporate sensors within the PV generating facility 400, and to active components such as breakers (not shown) disposed along the outgoing line 444 and/or the inverter electrical output lines 455. The hardware module may incorporate control from the PLC component to one or more separate electrical boards which host various electrical components, including breakers, AC disconnection apparatus, fused, and other isolation systems. In addition, signal lines at the generating facility, local connection point, or from the premises at which the generating facility is installed may be physically connected through to the hardware module. For example, a signal line identifying a buildings fire alarm, a signal line from the grid connection point, or a signal line referencing the state of a local substation may are example embodiments (not shown). The hardware module 410 further comprises an electrical interconnection interface 460 for electrical interconnections such as to the outgoing line 444 and the inverter electrical output lines 455. For example, the hardware module 410 is connected with signal lines 462, 464 to read out from the outgoing line 444 and the inverter electrical output lines 455.

### Interconnectivity Examples to the AC Electrical Power Grid Network

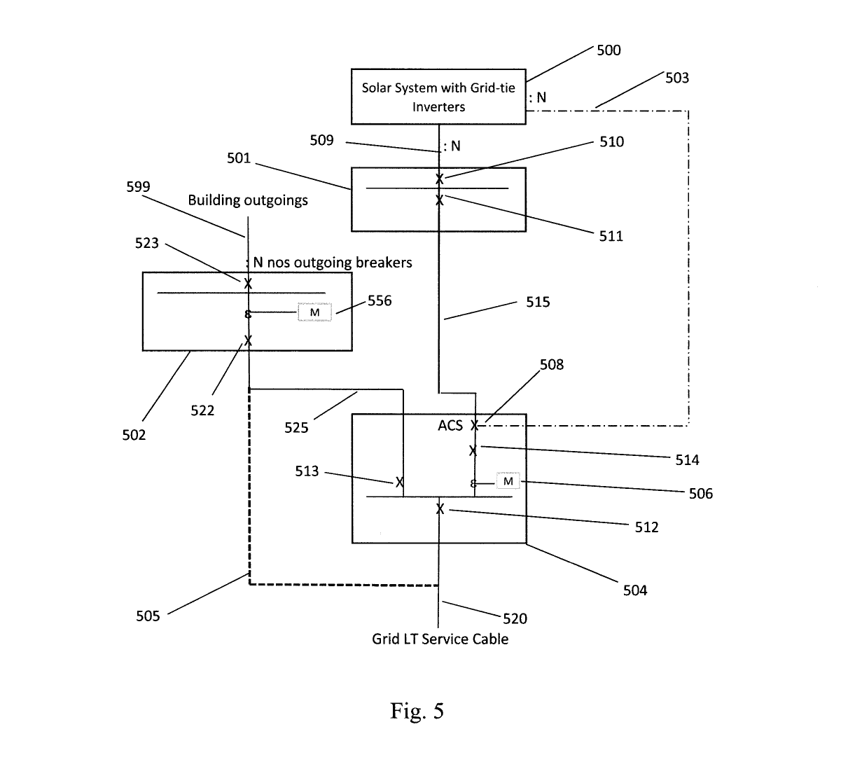

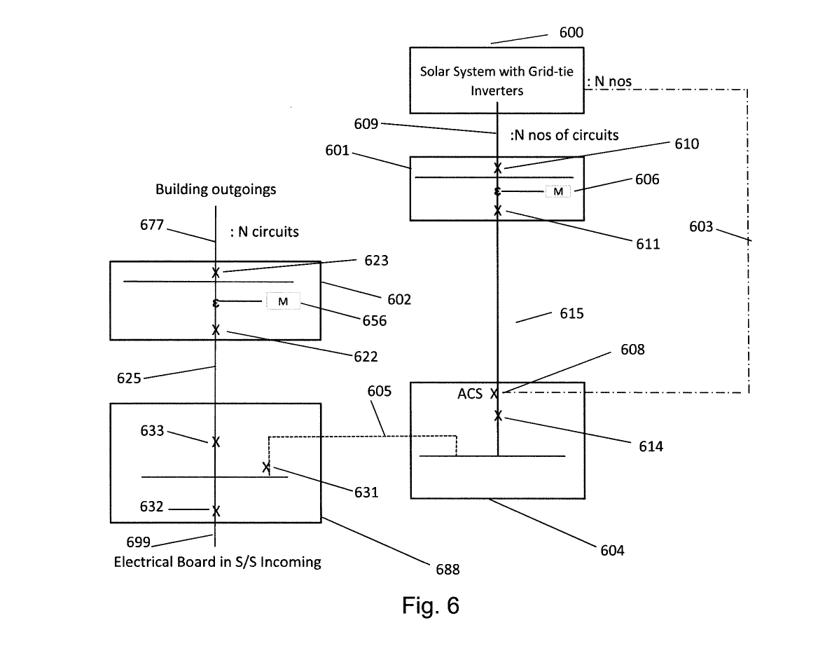

The connection point 490 can include, but is not limited to, a substation, a service cable, a step up transformer or any other connection point for output of the PV energy. For illustration, two connection implementation examples are described below with reference to FIG. 5 and FIG. 6.

The following example interconnection mechanism is implemented while the generating facility is to be connected at a buildings service cable labelled 520, as shown in FIG. 5. The service cable capacity will be installed or otherwise verified to be able to accept the full capacity to transmit the solar power generated by the generator to the grid network. This service cable 520 will be connected back to the substation of the power network, and so is able to carry power into the electricity network. FIG. 5 demonstrates an interconnection of a solar power generator to the power grid distribution network. In this case the incoming line from the solar energy system 500 enters a solar sub-board 501 with breakers 510 and 511. The solar sub-board 501 connections 515 enter an additional connection board 504 housing breakers 512, 513 and 514. This connection board 504 holds an additional auto cut off switch 509 at the incoming line 515.

500 is a solar energy system comprised of an array or arrays of photovoltaic modules, and the array based on strings of solar panels and solar inverters. The inverters are grid tie inverters and the system is configured to include dual pole complete wave alternating current isolator(s), or similar. 501 is a sub-board for solar system interconnections. 502 is a building main switchboard. 503 is an additional synchronizing relay cut off pilot cable with one or multiple relays depending on the number of strings in the solar system 500.

504 is an additional connection board housing breakers and auto cut of switch 508. 505 is the original service cable to the building. 506 is a suggested location for a grid grade revenue meter complete with a telephone line to measure output from the Solar Power Supply 500. 508 is an automatic cut of switch. 509 are the outgoing line or lines of the solar system to the solar sub-board 501. There may be more than one string of units incoming to the solar sub-board at 501. 510 is a single incoming breaker or multiple breakers installed within the solar sub-board 501. 511 is an outgoing breaker installed within the solar sub-board 501.

512 is a grid incoming breaker housed within the additional connection board 504. 513 is a outgoing breaker housed within the additional connection board 504. 514 is an incoming breaker for the solar generation connection. 515 is a connection line feeding power from the solar sub-board 501 through the additional connection board 504 into the power grid. 520 is a power grid incoming service cable.

522 is an incoming breaker housed within the main switchboard 502. 523 is a single or multiple number of outgoing breakers housed within the main switchboard 502. 556 is a suggested location for a grid grade revenue meter complete with a telephone line for building incoming supply. 599 is the plurality of building outgoing supply lines (N total units).

All the solar generators 500 inverters are of grid tie type incorporated with automatic AC disconnectors for isolation of the solar power supply in the absence of a grid AC supply from the power grid via a new grid service cable 520. An additional connection board 504 is installed as an interconnection point for the grid power supply 512 to the main switchboard 502. The original service cable 505 connecting the power grid supply 520 to the main switchboard 502 is routed to connect onto the grid incoming breaker 512 of the additional connection board 504. A new service cable 525 is installed from the outgoing breaker 513 of the additional connection board 504 to the main switchboard 502. New power cable(s) 509 are installed from the outgoing breaker(s) 510 from the solar power system 500 (subjected to the numbers of solar panel strings) to the solar sub-board 501 and connected to the additional connection board 504. A pilot cable 503 is installed having an interlocking cut-off of the auto cut-off switch (ACS) breaker 508 on the additional connection board 504 together with all the built-in automatic AC disconnectors on solar generators inverters 500 to cause additional isolation of the solar power supply 500 in the absence of a alternating current supply sensed on the power grid.

Once all the synchronising relays of the solar inverters detect that there is a power grid failure or shut-down, both the auto cut-off switch breaker 508 on the additional connection board 504 and the automatic AC disconnectors on solar generators inverters installed in the solar energy system 500 shall cut-off, thus, isolating the solar power supply 500 from feeding into the power grid network. On the other hand, once one of the synchronising relays of the solar inverters detect that the grid supply 520 is resumed, both the auto cut-off switch breaker 508 on the additional connection board 504 together and the automatic AC disconnectors on the solar generators 500 inverters shall switch back after the solar power supply is synchronised with the power grid AC supply, connecting the solar power supply back into the power grid network.

The electrical interconnections systems described are designed to cause automated shut down due to a power grid black out or due to planned servicing events where shut down occurs at the building or at the grid sub-station. In the event of a fire emergency, the grid power supply will shut down when isolation has adapted its signal from this alarm. In this event, the solar energy interconnections apparatus described will also turn off the solar power supply to the power grid. Additional alarms may be incorporated into the additional connection board 504 so that multiple channels may be utilized to create an automated isolation of the solar energy system 500 from the power grid network. I.e. if automatic cut-off fails, any electrical worker can also isolate the Solar Power Supply from the grid upon hearing the alarm. By manual turn off solar power supply incoming breaker 514 on the additional connection board, the solar power supply 500 will cut off from the grid network.

The following example interconnection mechanism is implemented while the generating facility is to be connected to an existing power grid low tension switchboard 688 at the power grid sub-station, as shown in FIG. 6. Numeral 600 is a solar energy system comprised of an array or arrays of photovoltaic modules, and the array based on strings of solar panels and solar inverters. The inverters are grid tie inverters and the system is configured to include dual pole complete wave alternating current isolator(s) or similar. Numeral 601 is a solar sub-board taking in one or more than one strings from the solar energy system 600. The solar sub-board 601 includes an incoming breaker 610 and an outgoing breaker 611.

602 are a building main switchboard or more than one main switchboard. Numeral 603 is an additional synchronizing relay cut off pilot cable with one or multiple relays depending on the number of strings in the solar system 600. Numeral 604 is an additional sub connection board for connection of the solar energy system sub-board 601 through to an existing power grid low tension switchboard 688 at the power grid sub-station.

Numeral 605 is a solar power service cable supplying power to the existing power grid rid low tension switchboard 688 from the additional sub connection board 604. Numeral 606 is a suggested location for a grid grade revenue meter complete with a telephone line for measuring the output of the Solar Power Supply 600. Numeral 608 is an automatic cut off switch. Numeral 609 is a single or more than one incoming supply line from the solar energy system 600 to the solar sub-board 601. Numeral 610 is an incoming breaker of the solar sub-board 601. Numeral 611 is the outgoing breaker or multiple breakers installed in the solar sub-board 601.

614 is an incoming breaker at the additional sub connection board 604. Numeral 615 is the conductor cable taking power from the solar sub-board 601 supplying power through the additional sub connection board 604 into the power grid. Numeral 622 is an incoming breaker at the main switchboard 602. Numeral 623 is an outgoing breaker at the main switchboard 602. Numeral 625 is the conductor supplying power through the existing power grid low tension switchboard 688 to the building main switchboard 602. Numeral 631 is a new incoming breaker for the existing grid power grid low tension low tension switchboard 688 in the power grid sub-station connecting to the solar incoming line 605 and to the additional sub connection board 604.

Numeral 632 is an incoming breaker for the existing power grid low tension switchboard 688 connected to the grid incoming supply 699 in the power grid sub-station. Numeral 633 is an outgoing breaker in the existing grid power low tension switchboard 688. Numeral 656 is a suggested location for a grid grade revenue meter complete with a telephone line for measuring the incoming power supply 625 for the building. Numeral 677 is the outgoing or more than one outgoing supply lines to building(s). Numeral 688 is an existing low tension switchboard at the power grid sub-station. Numeral 699 is an incoming service cable from the power grid supply network supplying power to the existing power grid low tension switchboard 688.

All the solar generators inverters 600 are of grid tie type incorporated with an automatic AC disconnector for isolation of the solar power supply in the absence of AC supply from the power grid via grid incoming service cable 699. An additional connection board 604 is to be installed within the power grid sub-station connect onto the additional cut off breaker 631 on the existing low tension main board 688 via a new service cable 605. A new power cable 615 is installed from the solar power outgoing breaker 611 of the solar sub-board 601 to the additional connection board 604.

A pilot cable 603 is installed having an interlocking cut-off of the auto cut-off switch breaker 608 on the additional connection board 604 together with all the built-in automatic AC disconnectors in the solar generators 600 inverters for additional isolation of the solar power supply 600 in the absence of power grid AC supply via the grid service cable 699. Once the synchronising relay of the solar inverters 600 detect that there is a power grid main failure or shut-down, both the auto cut-off switch breaker 608 on the additional connection board 604 together with the automatic AC disconnectors installed in the solar generators inverters 600 shall cut-off, isolating the solar power supply from feeding into the power grid network via the existing low tension switchboard 688.

On the other hand, once the synchronising relay of the solar inverters sense that the power grid low tension supply is resumed, both the auto cut-off switch breaker 608 on the additional connection board 604 together and the built-in automatic AC disconnectors in the solar generators 600 inverters shall switch back after the solar power supply is synchronised with the AC supply of the power grid via the existing low tension main board 688, connecting the solar power supply back into the power grid network via grid service cable 699.

The above are applicable for a power grid blackout or a planned servicing by the grid by implementing the above electrical apparatus. In the event of a fire emergency, by switching off the power grid supply shall also isolate the solar power supply to the grid and the other buildings. Additional alarms may be incorporated into the additional connection board 604 so that multiple channels may be utilized to create an automatic isolation of the solar energy system 100 from the power grid network. I.e. if automatic cut-off fails, any electrical worker can also isolate the solar power supply from the grid upon sensing the alarm. By manually turn off solar power supply incoming breaker 614 on the additional connection board or the additional cut off breaker 631 on the existing low tension main board 688, will cut-off the solar power supply from the grid network.

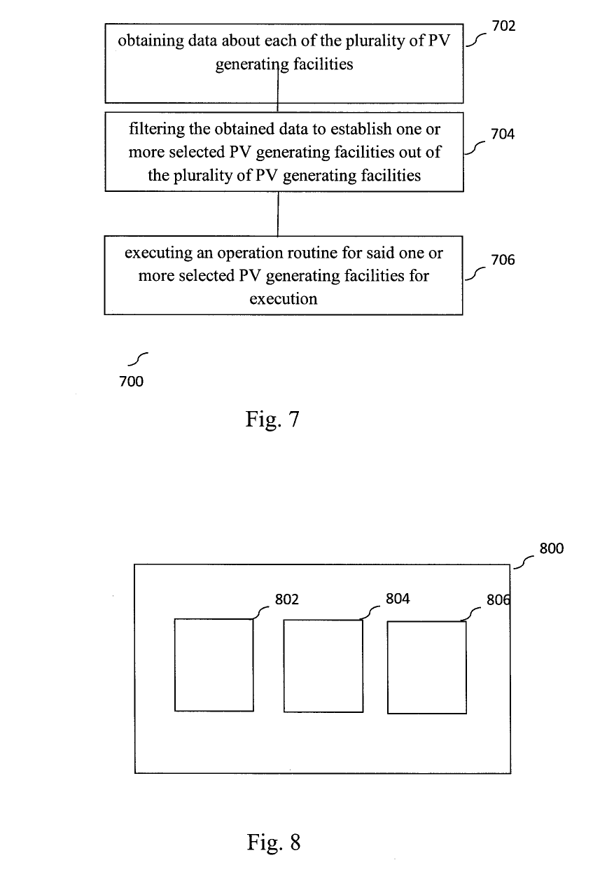

FIG. 7 shows a flow-chart 700 illustrating a method for operating a plurality of photovoltaic (PV) generating facilities connected to an electrical power grid network. At step 702, data about each of the plurality of PV generating facilities is obtained. At step 704, the obtained data is filtered to establish one or more selected PV generating facilities out of the plurality of PV generating facilities. At step 706, an operation routine is uploaded to said one or more selected PV generating facilities for execution.

The operation routine may be uploaded to respective hardware modules comprised in the one or more selected generating facilities for implementation locally at the one or more selected generating facilities upon receipt of a trigger signal at the respective hardware modules.

Trigger signals may comprise a variety of data/information both remote and local to a generating facility. Local data exemplifying a trigger signal may include but is not limited to a clock, voltage of electrical information from the AC electrical power grid network, feedback signals from the synchronizer, physical interconnection cables such as an inter-trip or inter-lock cable to the substation, a sensor cable detecting meteorological information or detecting various information from the PV system such as thermal data or otherwise. Remote data exemplifying a trigger signal may include but is not limited to information sent from a third party such as a PSO, signal commands sent from the operation centre, requests of the AC electrical power grid network administrator, timing signals, timing sequences and pulses, two way command and confirm communication sequences and subsets of such communications, and electrical disconnection commands. Trigger signals may also be comprised as a combination of both local and remote data/information. For example, the operation centre may receive a signal from a local hardware module from which it computes a command which is sent back to the local hardware module for execution.

The operation routine may be uploaded to respective hardware modules comprised in the one or more selected generating facilities for implementation locally through a schedule implemented to a clock comprised in the respective hardware modules.

The method may comprise selecting an isolation routine as the operation routine which, when executed, isolates one or more PV generators at each of the one or more selected PV generating facilities from a connection point to the building load or AC electrical power grid network.

The method may comprise selecting a synchronization routine as the operation routine which, when executed, sets a reference waveform for synchronization of AC output from respective AC inverters coupled to one or more PV generators at each of the one or more selected PV generating facilities.

The method may comprise selecting a reactive power control routine as the operation routine which, when executed, sets a reference waveform for reactive power control of AC output from respective AC inverters coupled to one or more PV generators at each of the one or more of selected PV generating facilities.

The method may comprise selecting a maintenance routine as the operation routine which, when executed, performs a maintenance operation on one or more PV generators at each of one or more selected PV generating facilities.

Obtaining the data about each of the plurality of PV generating facilities may comprise receiving information from the PV generating facilities.

Obtaining the data about each of the plurality of PV generating facilities may comprise receiving information from a power system operator (PSO) or an administrator of the electrical power grid network. The information from the PSO or administrator of the electrical power grid network may be encrypted.

The method may comprise diverting power to an auxiliary or dump back up system associated with the one or more selected PV generating facilities.

FIG. 8 shows a schematic drawing illustrating a system for operating a plurality of photovoltaic (PV) generating facilities connected to an electrical power grid network, comprising means 802 for obtaining data about each of the plurality of PV generating facilities; means 804 for filtering the obtained data to establish one or more selected PV generating facilities out of the plurality of PV generating facilities; and means 806 for executing an operation routine for said one or more selected PV generating facilities for execution.

The system 800 including the means 802, 804 and 806 are implemented on a computer module in this example embodiment, with input modules such as a touchscreen, keyboard and mouse and a plurality of input and/or output devices such as a display, printer, etc.

The computer module is connected to a computer network via a suitable transceiver device to enable access to the Internet and or other network systems such as a Local Area Network (LAN) or a Wide Area Network (WAN). The computer module in the example includes a processor, a Random Access Memory (RAM) and a Read Only Memory (ROM). The computer module also includes a number of Input/Output (I/O) interfaces, for example an I/O interface to the display and an I/O interface to the keyboard and an I/O interface.

The components of the computer module typically communicate via an interconnected bus and in a manner known to the person skilled in the relevant art. Application program(s) for instructing the computer module to implement the system 800 is typically supplied to the user of the computer system encoded on a data storage medium such as a CD-ROM or flash memory carrier and read utilizing a corresponding data storage medium drive of a data storage device. The application program is read and controlled in its execution by the processor of the computer module. Intermediate storage of program data may be accomplished using the RAM of the computer module.

The means for 806 uploading may be configured to upload the operation routine to respective hardware modules of the system comprised in the one or more selected generating facilities for implementation locally at the one or more selected generating facilities upon receipt of a trigger signal at the respective hardware modules.

The means 806 for uploading may be configured to upload the operation routine to respective hardware modules of the system comprised in the one or more selected generating facilities for implementation locally through a schedule implemented to a clock comprised in the hardware module.

Each hardware module may comprise one or more of a group consisting of a communication unit, a programmable logic controller (PLC), a memory and a processor.

The hardware module may further comprise a data storage space for storing at least part of the operation routine.

The hardware module may further comprise a data acquisition unit for gathering data locally at the PV generating facility.

The system may comprise means for selecting an isolation routine as the operation routine which, when executed, isolates one or more PV generators at each of the one or more selected PV generating facilities from the AC electrical power grid network.

The system may comprise means for selecting a synchronization routine as the operation routine which, when executed, sets a reference waveform for synchronization of AC output from respective AC inverters coupled to one or more PV generators at each of the one or more selected PV generating facilities.

The system may comprise means for selecting a reactive power control as the operation routine routine which, when executed, sets a reference waveform for reactive power control of AC output from respective AC inverters coupled to one or more PV generators at each of the one or more of selected PV generating facilities.

The system may comprise means for selecting a maintenance routine as the operation routine which, when executed, performs a maintenance operation on one or more PV generators at each of one or more selected PV generating facilities.

The means 802 for obtaining data about each of the plurality of PV generating facilities may be configured to receive information from the PV generating facilities.

The means 802 for obtaining data about each of the plurality of PV generating facilities may be configured to receive information from a power system operator (PSO) or an administrator of the electrical power grid network.

The system may be configured such that the information from the PSO or administrator of the of the electrical power grid network is encrypted.

The system may comprise means for storing the data obtained by the means for obtaining data about the aggregate PV generating facility.

The system may comprise means for storing a plurality of operating routines, and means for selecting the operating routine for uploading by the means for uploading.

The hardware module may further comprise a data storage space for storing information received from the PV generating facilities and associated sensors.

The system may comprise means for diverting power to an auxiliary or dump back up system associated with the one or more selected PV generating facilities.

In one embodiment, an aggregate generating facility is provided comprising a plurality of PV generating facilities, each PV generating facility being configured to establish two way communication to an operation centre and comprising a functional control apparatus, for establishing an operating platform of the aggregate generating facility.

In one embodiment, an operation centre for a plurality of PV generating facilities is provided, the operation centre being configured to establish two way communication to each of the generating facilities, wherein the operation centre is further configured to identify a set of the PV generating facilities and to execute commands to respective functional control apparatus of the set of PV generating facilities.

In one embodiment, an operation method for a plurality of PV generating facilities is provided comprising performing a operation routine one one or more PV generators at each of one or more of the PV generating facilities using a central operation platform.

The operation routine may comprise isolating one or more PV generators at each of one or more of the PV generating facilities from a connection point to the building load or AC electrical power grid network using the central operation platform.

The operation routine may comprise setting a reference waveform for synchronization of AC output from respective AC inverters coupled to one or more PV generators at each of one or more of the PV generating facilities using the central operation platform.

The operation routine may comprise setting a reference waveform for reactive power control of AC output from respective AC inverters coupled to one or more PV generators at each of one or more of the PV generating facilities using the central operation platform and optionally a stabilized reference clock of the one or more selected generating facilities.

The operation routine may comprise performing a maintenance operation on one or more PV generators at each of one or more of the PV generating facilities using the central operation platform.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features, in particular any combination of features in the patent claims, even if the feature or combination of features is not explicitly specified in the patent claims or the present embodiments.

For example, while the embodiments have been described in the context of an AC electrical power grid network, embodiments of the present invention can also be implemented for DC networks. In this case, while an inverter would not be needed, the connectivity of a generating facility to the DC electrical power grid network would be maintained, i.e. for controlling the other aspects such as information obtained, breakers, or storage, or isolation commands etc., as described above in relation to the example embodiments.

1. A method for operating a plurality of photovoltaic (PV) generating facilities connected to an electrical power grid network, the electrical power grid network further comprising a plurality of dispatchable generators and a power system operator (PSO) providing a dispatch routine for the dispatchable generators, the method comprising the steps of:
obtaining data about each of the plurality of PV generating facilities, comprising receiving information from the PV generating facilities and receiving information from the PSO;
filtering the obtained data including the information from the PSO to establish one or more selected PV generating facilities out of the plurality of PV generating facilities; and
executing an operation routine for said one or more selected PV generating facilities, wherein the operation routine includes limiting supply of energy from the selected PV generating facilities to the electrical power grid network based on the information received from the PSO.

2. The method as claimed in claim 1, wherein the information from the PV generating facilities comprises information about an output of the plurality of PV generating facilities or of a subset thereof.

3. The method as claimed in claim 1, wherein limiting supply of energy from the selected PV generating facilities comprises diverting power to an auxiliary or dump back up system associated with the one or more selected PV generating facilities.

4. The method as claimed in claim 1, wherein the operation routine is uploaded to the respective hardware modules comprised in the one or more selected generating facilities for implementation locally at the one or more selected generating facilities, or wherein the operation routine is uploaded to the respective hardware modules comprised in the one or more selected generating facilities for implementation locally through a schedule implemented to a clock comprised in the respective hardware modules.

5. (canceled)

6. The method as claimed in claim 1, comprising selecting an isolation routine as the operation routine which, when executed, isolates one or more PV generators at each of the one or more selected PV generating facilities from a connection point to the building load or AC electrical power grid network.

7. The method as claimed in claim 1, comprising selecting a synchronization routine as the operation routine which, when executed, sets a reference waveform for synchronization of AC output from respective AC inverters coupled to one or more PV generators at each of the one or more selected PV generating facilities.

8. The method as claimed in claim 1, comprising selecting a reactive power control routine as the operation routine which, when executed, sets a reference waveform for reactive power control of AC output from respective AC inverters coupled to one or more PV generators at each of the one or more of selected PV generating facilities.

9. The method as claimed in claim 1, comprising selecting a maintenance routine as the operation routine which, when executed, performs a maintenance operation on one or more PV generators at each of one or more selected PV generating facilities.

10. (canceled)

11. The method as claimed in claim 1, comprising diverting power to an auxiliary or dump back up system associated with the one or more selected PV generating facilities.

12. A system for operating a plurality of photovoltaic (PV) generating facilities connected to an electrical power grid network, the electrical power grid network further comprising a plurality of dispatchable generators and a power system operator (PSO) providing a dispatch routine for the dispatchable generators, the method comprising:
means for obtaining data about each of the plurality of PV generating facilities, comprising receiving information from the PV generating facilities and receiving information from the PSO;
means for filtering the obtained data including the information from the PSO to establish one or more selected PV generating facilities out of the plurality of PV generating facilities; and
means for executing an operation routine for said one or more selected PV generating facilities, wherein the operation routine includes limiting supply of energy from the selected PV generating facilities to the electrical power grid network based on the information received from the PSO.

13. The system as claimed in claim 12, wherein the information from the PV generating facilities comprises information about an output of the plurality of PV generating facilities or of a subset thereof.

14. The system as claimed in claim 12, wherein limiting supply of energy from the selected PV generating facilities comprises diverting power to an auxiliary or dump back up system associated with the one or more selected PV generating facilities.

15. The system as claimed in claim 12, wherein the means for executing is configured to upload the operation routine to the respective hardware modules of the system comprised in the one or more selected generating facilities for implementation locally at the one or more selected generating facilities, or wherein the means for executing is configured to upload the operation routine to the respective hardware modules of the system comprised in the one or more selected generating facilities for implementation locally through a schedule implemented to a clock comprised in the hardware module.

16. (canceled)

17. (canceled)

18. The system as claimed in claim 12, wherein the hardware module further comprises a data storage space for storing at least part of the operation routine and/or wherein the hardware module further comprises a data acquisition unit for gathering data locally at the PV generating facility.

19. (canceled)

20. The system as claimed in claim 12, comprising means for selecting an isolation routine as the operation routine which, when executed, isolates one or more PV generators at each of the one or more selected PV generating facilities from the AC electrical power grid network.

21. The system as claimed in claim 12, comprising means for selecting a synchronization routine as the operation routine which, when executed, sets a reference waveform for synchronization of AC output from respective AC inverters coupled to one or more PV generators at each of the one or more selected PV generating facilities.

22. The system as claimed in claim 12, comprising means for selecting a reactive power control as the operation routine which, when executed, sets a reference waveform for reactive power control of AC output from respective AC inverters coupled to one or more PV generators at each of the one or more of selected PV generating facilities.

23. The system as claimed in claim 12, comprising means for selecting a maintenance routine as the operation routine which, when executed, performs a maintenance operation on one or more PV generators at each of one or more selected PV generating facilities.

24. (canceled)

25. The system as claimed in claim 12, comprising means for storing the data obtained by the means for obtaining data about the aggregate PV generating facility and/or for storing a plurality of operating routines, and means for selecting the operating routine for uploading by the means for uploading.

26. (canceled)

27. (canceled)

28. The system as claimed in claim 12, comprising means for diverting power to an auxiliary or dump back up system associated with the one or more selected PV generating facilities.
